(19) United States
(12) Patent Application Publication
(10) Pub. No.: US 2007/0010905 A1
(43) Pub. Date: Jan. 11, 2007

(54) Systems and methods for monitoring processing tool

(75) Inventor: Alton Chou, Zhubei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Taiwan Semiconductor Manufacturing Co., Ltd.

(21) Appl. No.: 11/176,077

(22) Filed: Jul. 7, 2005

(51) Int. Cl. G06F 19/00

(52) U.S. Cl. 700/108; 700/121

(57) ABSTRACT

A system is provided, electronically collecting and processing data obtained from processing tool. The system comprises a data collecting device and a processor. The data collecting device collects process data obtained from equipment via a network, the process data not defined in a SECS (semiconductor equipment communication standard) protocol. The processor determines whether the collected process data conforms to a preset rule based on a historical record of process data.

### BACKGROUND

The present invention relates to fabrication processes and particularly to a system and method for detecting non-SECS (Semiconductor Equipment Communications Standard) processing events in processing equipments.

During semiconductor manufacture, a large amount of process data is generated. Most process or metrology equipment would generate and store process data. The described process data may specify process conditions within equipment (for example, process duration, process temperature, or process gas flow), operating conditions of the equipment (for example, alarm states, input/output (I/O) signal traces, and vacuum or pressure levels), and/or general historical data for the equipment (for example, last preventive maintenance (PM) or next PM date). Process data may also comprise various substrate feature measurements, such as film thickness mapping, particle mapping, die-to-database correlations, step height values, and line-width measurements.

Semiconductor Equipment Communications Standard (SECS) protocol is a widely used international consensus-based standard produced by SEMI (Semiconductor Equipment and Materials International). Typically, the SECS protocol communicates actively via the equipment serial port. Data available using a SECS protocol provides equipment and material information such as wafer information, wafer lot number, cassette slot number being processed, recipe name, and process parameters.

However, beyond the basic data defined in the SECS, the ability to monitor processing equipment in real time has been limited. Many processing events cannot be detected using SECS-defined process data.

Hence, there is a need for a process monitoring system that addresses the inefficiency arising from the existing technology.

### SUMMARY

A system is provided to electronically collecting and processing data obtained from processing equipment. The system comprises a data collecting device and a processor. The data collecting device collects process data obtained from equipment via a network, wherein the process data is not defined in a SECS (semiconductor equipment communication standard) protocol. The processor determines whether the collected process data conforms to a preset rule based on a historical record of process data.

A manufacturing system is provided. The manufacturing system comprises equipment, a monitoring device, and a controller. The equipment processes an article. The monitoring device, coupled to the equipment, collects non-SECS process data generated by the equipment, and screens event data from the collected non-SECS process data based on a historical record of non-SECS process data generated in preceding processing runs of the equipment. The controller receives the event data from the monitoring device, and adjusting operation of the equipment according to the event data.

A method is also provided, electronically collecting and processing data obtained from processing equipment. First, process data is obtained from processing equipment, the process data not defined in a SECS (semiconductor equipment communication standard) protocol. Next, it is determined whether the collected process data conforms to a preset rule based on historical process data.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic view of an exemplary embodiment of a manufacturing system according to the invention; and

FIG. 2 is a flowchart of an exemplary embodiment of an equipment monitoring method of the invention.

### DETAILED DESCRIPTION

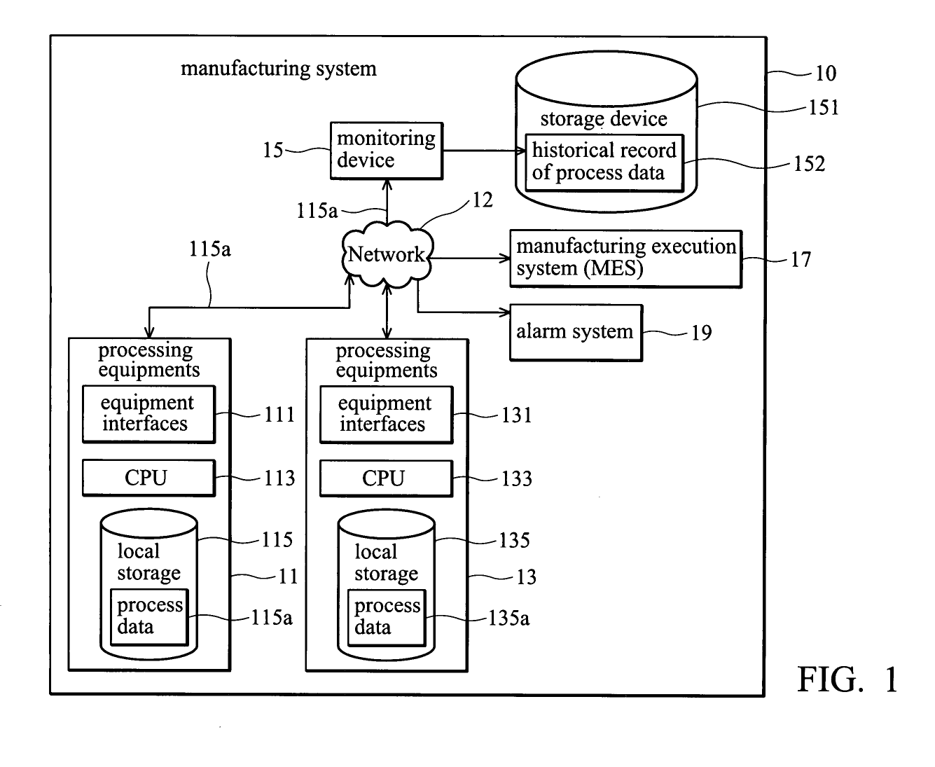

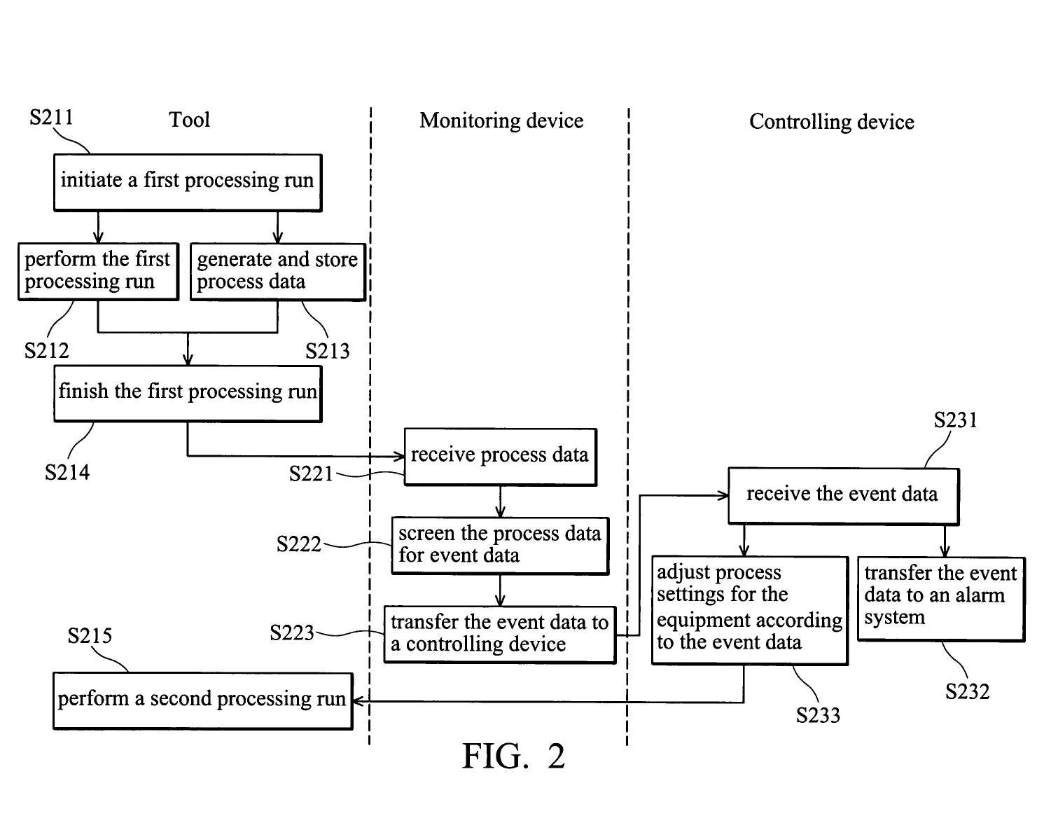

Exemplary embodiments of the invention will now be described with reference to FIGS. 1 and 2, which generally relate to a manufacturing system implementing non-SECS process event monitoring.

In the following detailed description, reference is made to the accompanying drawings which form a part hereof, and in which is shown by way of illustration of specific embodiments. These embodiments are described in sufficient detail to enable those skilled in the art to practice the invention, and it is to be understood that other embodiments may be utilized and that structural, logical and electrical changes may be made without departing from the spirit and scope of the present invention. The following detailed description is, therefore, not to be taken in a limiting sense. The leading digit(s) of reference numbers appearing in the Figures corresponds to the Figure number, with the exception that the same reference number is used throughout to refer to an identical component which appears in multiple Figures.

FIG. 1 is a schematic view of an exemplary embodiment of a manufacturing system according to the invention. A manufacturing system 10 processes semiconductor products, and it comprises processing tools 11 and 13, a monitoring device 15, a manufacturing execution system (MES) 17, and an alarm system 19.

Processing tools 11 and 13 each is capable of processing at least one wafer at a time. Processing tools 11 and 13 can be any instrument, machine, or device used to perform a task or measure a characteristic or quality of a substrate or the like.

Each processing tool has an associated equipment interface connected to a network 12, such as a local area network (LAN) For example, processing tools 11 and 13 have associated equipment interfaces 111 and 131, respectively. Process data 115a and 135a generated during operation is stored in local storage unit 115 and 135 of the processing tools 11 and 13, respectively. For example, central processing unit (CPU) 113 of processing tool 11 stores process data 115a generated during operation in local storage unit 115. Similarly, central processing unit (CPU) 133 of processing tool 13 stores process data 135a generated during operation in local storage 135. When a process run is performed by a processing tool, corresponding process data is generated and stored in a local storage unit of the processing tool. When the process run is completed, the stored process data 115a is transferred to the monitoring device 15, via the network 12, for further processing.

Processing tools 11 and 13 may also comprise associated SECS interfaces (not shown). The SECS interface may be a communication port, such as an RS-232 serial port, running a SECS protocol. The SECS protocol defines details for the electronic transmission of messages between the plurality of tools and other devices within the manufacturing system 10. The SECS interface allows a limited set of process data relevant to the corresponding tool to be transmitted electronically, such as tool identifier, module identifier, wafer information, wafer lot number, cassette slot number being processed, recipe name, and process parameters etc. According to the embodiment, process data not defined in the SECS is collected and processed by the monitoring device 15 and other pertaining device, therefore, collecting and processing the SECS-defined process data is not detailed here.

The network 12 is part of a communications network within the manufacturing system 10. In one exemplary embodiment, the NETWORK 12 allows communication using Ethernet packets transmitted between the processing tools.

The monitoring device 15 is coupled to processing tools 11 and 13 via the NETWORK 12 via tool interfaces 111 and 131. When a process run is completed, the stored process data 115a is transferred to the monitoring device 15, via the NETWORK 12, for further processing. Here, the process data 115a comprises a large amount of non-SECS data, transferred according to a file transfer protocol (FTP). Historical record of process data 152 generated in a plurality of processing runs is stored in storage device 151. When process data 115a generated during a new processing run is received, the historical record of process data 152 is regarded as historical process data and used to determine whether the process data 115a comprises data specifying a processing event (hereinafter referred to as event data). When event data is detected, the event data is transferred to MES 17, and used as a reference for tool control. Additionally, the event data is transferred to an alarm system 19, whereby an alarm is generated and output via e-mail message or phone or other suitable means.

FIG. 2 is a flowchart illustrating an exemplary embodiment of a method of the invention. The method shown in FIG. 2 collects non-SECS process data generated during a processing run, screening event data from the collected process data to detect a process event and adjust processing tools accordingly.

Referring to FIG. 2, a first processing run is initiated in step S211. When the first processing run is performed by processing tool in step S212, process data is generated by the processing tool and recorded in a local storage unit of the processing tool in step S213. The generating and storing of the process data can be performed simultaneously or sequentially. After the first processing run is finished in step S214, the process data stored in a local storage is transferred to a monitoring device via a network, such as a TCP/IP network. The process data, comprising a large amount of non-SECS process data, can be transferred from the local storage unit of the processing tool to the monitoring device according to a file transfer protocol (FTP). In the monitoring device or a storage device connected thereto, process data 152 generated in a plurality of processing runs is stored as a historical record of process data. When monitoring device 15 receives process data during the first processing run (step S221), the historical record of process data is used to determine whether the process data of the first processing run comprises data specifying a process event (hereinafter referred to as event data) (step S222). If event data is detected, it is then transferred to a control device, such as a MES (step S223). In step S231, the event data is received, and used as a reference for tool control. In step S232, the event data is transferred to an alarm system, whereby an alarm is generated and output through e-mail message or phone, or other suitable means. In step S233, process settings for the equipment are adjusted according to the event data. In step S215, a second processing run is performed by the equipment according to the adjusted processing settings.

Here, monitoring of a stepper is described as an example. For a stepper, exposure dose is a critical factor for production yield, and the exposure dose is affected by operating status of an energy sensor and spot sensor in the exposure equipment. Spot sensor and energy sensor status is typically recorded as illumination automatic calibration (ILAC) data. The ILAC data can be recorded in many types of stepper, and is generally stored in a local hard disk of the stepper. Many steppers, however, cannot report the ILAC data to an external device via a SECS protocol. The ILAC data is recorded during exposure, and stored in a local hard disk of a stepper. After exposure is performed, the stored ILAC data is transferred to a monitoring device via a network, such as a TCP/IP network using a file transfer protocol. ILAC data obtained in a plurality of preceding processes is used as a basis for statistical analysis of ILAC data of a current processing run. For example, 40 entries of ILAC data obtained during preceding processing runs of a particular illumination mode are retrieved, and a mean value thereof calculated. When the difference between the ILAC data of the current processing run and the calculated mean value exceeds a preset value, the ILAC data of the current processing run is regarded as abnormal data specifying a process event in the current processing run. When event data is identified, an alarm signal is generated. Wafers for subsequent processing may be held until the stepper is adjusted properly. The event data is stored but excluded from the historical process data, whereby the event data does not serve as a basis for a statistical analysis for a subsequent processing run.

While the invention has been described by way of example and in terms of preferred embodiment, it is to be understood that the invention is not limited thereto. Those skilled in this technology can still make various alterations and modifications without departing from the scope and spirit of this invention. Therefore, the scope of the present invention shall be defined and protected by the following claims and their equivalents.

What is claimed is:

1. A system for electronically collecting and processing data obtained from processing tool, comprising:
a data collecting device for collecting process data from a processing tool via a network, wherein the process data is not pre-defined in a SECS (semiconductor equipment communication standard) protocol; and
a processor for determining whether the collected process data conforms to a preset rule based on a historical record of process data.

2. The system of claim 1, wherein the data collecting device collects the process data using a file transfer protocol (FTP) via a network.

3. The system of claim 1, wherein the data collecting device and the processor operate between processing runs of the equipment.

4. The system of claim 1, wherein the processor processes the historical record of process data using a statistical method to determine the preset rule.

5. The system of claim 1, wherein the processor further identifies the process data violating the preset rule as event data, and transfers the event data to an external system.

6. The system of claim 5, wherein the processor further transfers the event data to a manufacturing execution system (MES) controlling the equipment.

7. The system of claim 1, wherein the data collecting device collects illumination automatic calibration (ILAC) data of exposure equipment.

8. A manufacturing system, comprising:
a tool for processing an article;
a monitoring device, coupled to the tool, collecting non-SECS process data generated during a processing run of the tool, and screening predefined process data from the collected non-SECS process data based on a historical record of non-SECS process data generated in preceding processing runs of the tool; and
a controller coupled to receive the event data from the monitoring device, and control the tool according to the event data.

9. The manufacturing system of claim 8, wherein the monitoring device collects the process data using a file transfer protocol (FTP) via a network.

10. The manufacturing system of claim 8, wherein the monitoring device processes the historical record of process data using a statistical method to determine a preset rule.

11. The manufacturing system of claim 8, wherein the controller is a manufacturing execution system (MES) for controlling the tool.

12. The manufacturing system of claim 8, wherein the tool is an exposure tool.

13. The system of claim 12, wherein the monitoring device collects illumination automatic calibration (ILAC) data from the exposure tool.

14. A method for electronically collecting and processing data obtained from processing tool, comprising:
collecting process data generated during a processing run of the processing tool, wherein the process data is not defined in a SECS (semiconductor equipment communication standard) protocol; and
determining whether the collected process data conforms to a preset rule based on a historical record of process data.

15. The method of claim 14, further collecting the process data using a file transfer protocol (FTP) via a network.

16. The method of claim 14, further processing the historical record of process data using a statistical method to determine the preset rule.

17. The method of claim 14, further identifies the process data violating the preset rule as event data, and transferring the event data to an external system.

18. The method of claim 14, further transferring the event data to a manufacturing execution system (MES) controlling the processing tool.

19. The method of claim 14, further collecting process data from exposure equipment.

20. The method of claim 19, further collecting illumination automatic calibration (ILAC) data of the exposure equipment.
